(19) United States
(12) Patent Application Publication
(10) Pub. No.: US 2009/0042440 A1
(43) Pub. Date: Feb. 12, 2009

(54) Coaxial plug-in connector comprising a contact mechanism for electrical contact

(76) Inventors: Folke Michelmann, Tittmoning (DE); Willem Blakborn, Inzell (DE)

Correspondence Address: LAW OFFICE OF DELIO & PETERSON, LLC., 121 WHITNEY AVENUE, 3RD FLLOR, NEW HAVEN, CT, 06510, US

(21) Appl. No.: 11/631,270

(22) PCT Filed: Jun. 6, 2005
(86) PCT No.: PCT/EP05/06054

§ 371 Date: Feb. 9, 2007

(30) Foreign Application Priority Data
Jul. 1, 2004 (DE) 20 2004 010 325.7

(51) Int. Cl. H01R 9/05

(52) U.S. Cl. 439/578

(57) ABSTRACT

A coaxial connector for insertion of a complementary coaxial connector, in which a switching mechanism having an electrical contact is arranged and formed in the coaxial connector that the electrical contact is closed when there is not a complementary coaxial connector inserted in the coaxial connector, and the electrical contact is open when there is a complementary coaxial connector inserted in the coaxial connector, the arrangement made so that the switching mechanism has a cylindrical first conductor part which may be expanded and/or compressed radially with elastic resilience, and which makes electrical contact with a second conductor part of the switching mechanism, the first conductor part arranged and formed that a complementary coaxial connector which is inserted in the coaxial connector expands the first conductor part radially or compresses it radially, thus breaking the electrical contact between the first conductor part and the second conductor part.

### BACKGROUND OF THE INVENTION

1. Field of the Invention

The present invention relates to a coaxial connector, in particular an RF cable micro-connector, for the insertion of a complementary coaxial connector, a switching mechanism having an electrical contact being so arranged and formed in the coaxial connector that the electrical contact is closed when there is not a complementary coaxial connector inserted in the coaxial connector, and the electrical contact is open when there is a complementary coaxial connector inserted in the coaxial connector.

2. Description of Related Art

Coaxial connectors containing switches or a switching mechanism are used for example in mobile telephones for switching automatically from an internal aerial belonging to the mobile telephone to an external aerial which is connected to the coaxial connector by means of a coaxial cable, and conversely for switching back from the external aerial to the internal aerial when the coaxial cable which connects up the external aerial is withdrawn from the coaxial connector.

Known from DE 698 05 991 T2 is a coaxial switching connector which has an electrically conductive coaxial center conductor which extends from a rear part to a front part. Also included in the device is a second coaxial center conductor. The rear part of the first center conductor includes an electrically conductive movable part, which can be moved between a first position and a second position. The movable part is arranged to be in electrical contact with the second center conductor and to be electrically isolated from the front part of the first center conductor when the movable part is in the first position. The movable part is arranged to be in electrical contact with the front part and to be electrically isolated from the second center conductor when the movable part is in the second position. An actuator moves the movable part from the first position to the second position when a coaxial cable is fitted to the front part of the first center conductor.

Known from EO 0 993 080 A2 is a coaxial connector which is fitted with a switch. An insulating body of the coaxial connector is divided into two halves and contains a pair of switching elements of which one is arranged in each of the halves of the insulating body. When the two halves of the insulating body are assembled into a single unit, the two switching elements come into contact with each other. The switching elements, in the form of halves of a sprung fork, are arranged perpendicularly in the coaxial connector, the fork being forced apart by a center conductor of a male connector, which is inserted in the coaxial connector, and the electrical contact between the switching elements thus being broken. However, this switching arrangement has the disadvantage that, to allow the requisite resilient travel to be obtained, its structure is very long.

Known from DE 697 05 129 T2 is a coaxial switched connecting arrangement into which a mating coaxial male connector can be inserted and in which the switching contacts are arranged perpendicularly to a coaxial longitudinal axis, one of the contacts being deflected with elastic resilience by a pin-like center conductor of the mating male connector which is inserted in the switched connecting arrangement, by which means the electrical contact is opened. However, this arrangement has the disadvantage that the position of the pin-like center conductor of the mating male connector and the switching spring must be precisely matched to one another if the spring is not to be damaged in the insertion process. This system thus becomes expensive and complicated with regard to manufacture and assembly.

### SUMMARY OF THE INVENTION

Bearing in mind the problems and deficiencies of the prior art, it is therefore an object of the present invention to provide a coaxial connector, such as an RF cable micro-connector, for the insertion of a complementary coaxial connector with a switching mechanism having an electrical contact arranged and formed in the coaxial connector such that the electrical contact is closed when there is not a complementary coaxial connector inserted in the coaxial connector.

Another object of the present invention is to provide a coaxial connector having a switching mechanism that is a structure requiring very little space and can be manufactured and assembled easily and inexpensively.

Still other objects and advantages of the invention will in part be obvious and will in part be apparent from the specification and the claims.

The above and other objects, which will be apparent to those skilled in the art, are achieved in the present invention, which is directed to a coaxial connector for the insertion of a complementary coaxial connector comprising a switching mechanism having an electrical contact, arranged and formed in the coaxial connector such that the electrical contact is closed when there is not a complementary coaxial connector inserted in the coaxial connector, and the electrical contact is open when there is a complementary coaxial connector inserted in the coaxial connector, wherein the switching mechanism includes a cylindrical first conductor part radially expandable or compressible with elastic resilience and which makes electrical contact with a second conductor part of the switching mechanism, the first conductor part arranged and formed such that the complementary coaxial connector which is inserted in the coaxial connector expands the first conductor part radially or compresses said first conductor part radially to break electrical contact between the first conductor part and the second conductor part. The first conductor part may be arranged coaxially in the coaxial connector. The first conductor may include a sheet of resilient material formed into a roll

The coaxial connector may further include a contact tongue arranged and formed on the first conductor part such that when there is not a complementary coaxial connector inserted in the coaxial connector, the contact tongue makes electrical contact with the second conductor part of the switching mechanism and, when there is a complementary coaxial connector inserted in the coaxial connector, the electrical contact between the first and second conductor parts is broken due to the radial expansion or compression of the first conductor part by the complementary coaxial connector.

The coaxial connector may be formed to hold the first conductor part in a rolled state in opposition to an elastic resilient force, thus causing the contact tongue of the first conductor part to make contact with the contact area of the second conductor part when there is not a complementary coaxial connector inserted in the coaxial connector.

The first conductor may further include a slit in the axial direction and/or comprise a center-conductor part of the coaxial connector.

In a second embodiment, the present invention is directed to a coaxial connector for the insertion of a complementary coaxial connector comprising: a switching mechanism having an electrical contact, arranged and formed in the coaxial connector such that the electrical contact is closed when there is not a complementary coaxial connector inserted in the coaxial connector, and the electrical contact is open when there is a complementary coaxial connector inserted in the coaxial connector, wherein the switching mechanism includes: a cylindrical first conductor part radially expandable or compressible with elastic resilience and which makes electrical contact with a second conductor part of the switching mechanism, the first conductor part arranged and formed such that the complementary coaxial connector which is inserted in the coaxial connector expands the first conductor part radially or compresses the first conductor part radially to break electrical contact between the first conductor part and the second conductor part; and the contact tongue making electrical contact with the second conductor part of the switching mechanism such that when there is a complementary coaxial connector inserted in the coaxial connector, the electrical contact between the first and second conductor parts is broken due to the radial expansion or compression of the first conductor part by the complementary coaxial connector; the first conductor part arranged coaxially in the coaxial connector, comprising a sheet of resilient material formed into a roll, and including a funnel shaped form; and the coaxial connector formed to hold the first conductor part in a rolled state in opposition to an elastic resilient force, thus causing the contact tongue of the first conductor part to make contact with the contact area of the second conductor part when there is not a complementary coaxial connector inserted in the coaxial connector.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 is a perspective view showing a preferred embodiment of coaxial connector according to the invention.

FIG. 2 is a perspective, partly broken-away, view of the coaxial connector shown in FIG. 1.

FIG. 3 is a plan view from the insertion end of the coaxial connector shown in FIG. 1.

FIG. 4 is a view from below, from the side on which the printed-circuit board is situated, of the coaxial connector shown in FIG. 1.

FIG. 5 depicts the coaxial connector of FIG. 1 in section on line B-B of FIG. 4.

FIG. 6 depicts the coaxial connector of FIG. 1 in section on line C-C of FIG. 5.

### DESCRIPTION OF THE PREFERRED EMBODIMENT(S)

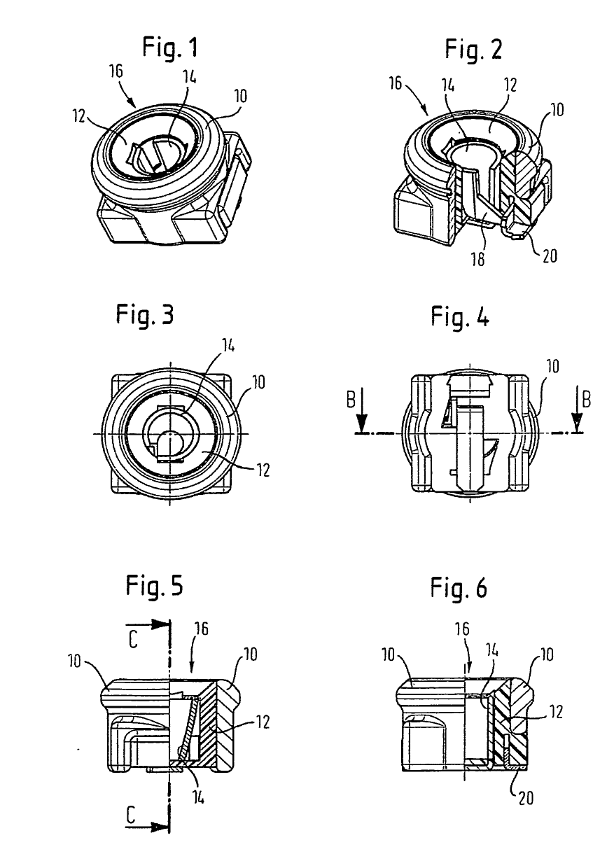

In describing the preferred embodiment of the present invention, reference will be made herein to FIGS. 1-6 of the drawings in which like numerals refer to like features of the invention.

In a coaxial connector of the above kind, provision is made in accordance with the invention for the switching mechanism to have a cylindrical first conductor part which can be expanded and/or compressed radially with elastic resilience, which first conductor part makes electrical contact with a second conductor part of the switching mechanism, the first conductor part being so arranged and formed that a complementary coaxial connector which is inserted in the coaxial connector expands the first conductor part radially or compresses it radially and thus breaks the electrical contact between the first conductor part and the second conductor part. This has the advantage that the switching mechanism is a structure requiring very little space and can be manufactured and assembled easily and inexpensively.

Advantageous coaxial guidance for the complementary coaxial connector when being inserted in the coaxial connector is obtained by arranging the first conductor part coaxially in the coaxial connector.

In a first embodiment, a contact tongue is so arranged and formed on the first conductor part that, when there is not a complementary coaxial connector inserted in the coaxial connector, the contact tongue makes electrical contact with the second conductor part of the switching mechanism and, when there is a complementary coaxial connector inserted in the coaxial connector, the electrical contact between the first and second conductor parts is broken due to the radial expansion or compression of the first conductor part by the complementary coaxial connector.

In a refinement of the invention, the first conductor part is a sheet of resilient material which is formed into a roll, the coaxial connector being so formed that it holds the first conductor part in the rolled state in opposition to an elastic resilient force from the latter, thus causing the contact tongue of the first conductor part to make contact with the contact area of the second conductor part when there is not a complementary coaxial connector inserted in the coaxial connector. A reduction in the insertion forces is achieved by forming the first conductor part to be funnel shaped. The first conductor part is usefully slit in the axial direction.

The preferred embodiment of coaxial connector according to the invention, which can be seen in FIGS. 1-6, comprises an outer-conductor part 10, an insulating part 12 in the form of a dielectric, and a center-conductor part 14. The center-conductor part 14 takes the form of a sheet of resilient material which is held in a roll in the insulating part 12 in opposition to a self-restoring spring action. In other words, the center-conductor part 14 takes the form of a slit, cylindrical sheet of resilient material which is arranged coaxially in the coaxial connector. The center-conductor part 14 may, in addition, be formed to be funnel-shaped, i.e., to taperin conically from an insertion end 16 of the coaxial connector, as can be seen in particular in FIG. 5.

The rolled center-conductor part 14 forms a first conductor element of a switch mechanism, having a contact tongue 18, as depicted in FIG. 2, which is arranged on the center-conductor part 14 on a side of the sheet of resilient material 14 remote from the insertion end 16 of the coaxial connector. It is at this point that the conically tapering center-conductor part 14 is of the smallest diameter. The contact tongue 18 makes electrical contact with a second conductor part 20 of the switching mechanism, as shown in FIG. 6. The second conductor part 20 is laterally arranged at an end of the coaxial connector remote from the insertion end 16 of the coaxial connector.

In the state shown in FIGS. 1-6, there is not a complementary coaxial connector, which will also be referred to in what follows as a “complementary male connector,” inserted in the coaxial connector according to the invention. The arrangement and form of the center-conductor part or first conductor element 14, 18 of the switching mechanism are such that in this state the contact tongue 18 makes electrical contact with the second conductor part. For this purpose, the force which is exerted on the sheet of resilient material 14 by the insulating part 12 to hold the sheet of resilient material 14 in the rolled state acts as a contact-making force for the electrical contact between the contact tongue 18 and the second conductor part 20 of the switching mechanism. In addition, suitable areas are provided on the contact tongue 18 and on the second conductor part 20 of the switching mechanism which act as contact areas for the electrical contact between the contact tongue 18 and the second conductor part 20 of the switching mechanism.

This electrical contact between the contact tongue 18 and the second conductor part 20 is used for example to connect in an internal aerial of a device, such as a mobile telephone for example, which has the coaxial connector according to the invention, when there is not a complementary male connector inserted in the coaxial connector. However, as soon as a complementary male connector is inserted in the coaxial connector, the complementary male connector expands the cylindrical center conductor 14 radially with its center conductor, which latter engages in the said cylindrical center conductor 14, the contact tongue 18 thereby being moved mechanically away from the second conductor element 20 of the switching mechanism. This results in the electrical contact between the contact tongue 18 and the second conductor part 20 of the switching mechanism being broken so that, for example, an aerial which is connected to the complementary male connector via a coaxial cable is connected to the device. As soon as the complementary male connector is withdrawn again from the coaxial connector according to the invention, the contact tongue 18 moves back to the original state where there was not a complementary male connector inserted, due to an elastic resilient force from the center-conductor part or sheet of resilient material 14, and restores the electrical contact to the second conductor part 20 of the switching mechanism.

Insertion forces are reduced by the conical form of the center-conductor part 14. Because of the production of the first conductive element 14, 18 in the form of a cylindrical, slit part, which is elastically resilient radially, the space required for the switching mechanism as a structure is reduced. The center-conductor part 14 ensures that a center-conductor pin of the complementary coaxial connector is guided coaxially until, for example, shortly before a printed circuit board on which the coaxial connector according to the invention is mounted in electrical contact is reached. The structure according to the invention of the switching mechanism is not sensitive to the depth of insertion of the complementary male connector, which means that less exacting tolerances need to be observed when the individual parts of the coaxial connector according to the invention are being manufactured. This reduces costs and simplifies assembly.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A coaxial connector for the insertion of a complementary coaxial connector comprising a switching mechanism having an electrical contact, arranged and formed in the coaxial connector such that the electrical contact is closed when there is not a complementary coaxial connector inserted in the coaxial connector, and the electrical contact is open when there is a complementary coaxial connector inserted in the coaxial connector, wherein the switching mechanism includes a cylindrical first conductor part radially expandable or compressible with elastic resilience and which makes electrical contact with a second conductor part of the switching mechanism, the first conductor part arranged and formed such that the complementary coaxial connector which is inserted in the coaxial connector expands the first conductor part radially or compresses said first conductor part radially to break electrical contact between the first conductor part and the second conductor part.

2. The coaxial connector of claim 1 further including having the first conductor part arranged coaxially in the coaxial connector.

3. The coaxial connector of claim 1 including having a contact tongue arranged and formed on the first conductor part such that when there is not a complementary coaxial connector inserted in the coaxial connector, the contact tongue makes electrical contact with the second conductor part of the switching mechanism and, when there is a complementary coaxial connector inserted in the coaxial connector, the electrical contact between the first and second conductor parts is broken due to the radial expansion or compression of the first conductor part by the complementary coaxial connector.

4. The coaxial connector of claim 1 wherein the first conductor part comprises a sheet of resilient material formed into a roll.

5. The coaxial connector according to claim 3 wherein the coaxial connector is formed to hold the first conductor part in a rolled state in opposition to an elastic resilient force, thus causing the contact tongue of the first conductor part to make contact with the contact area of the second conductor part when there is not a complementary coaxial connector inserted in the coaxial connector.

6. The coaxial connector of claim 1 having the first conductor part including a funnel shaped form.

7. The coaxial connector of claim 1 wherein the first conductor part includes a slit in the axial direction.

8. The coaxial connector of claim 1 wherein the first conductor part comprises a center-conductor part of the coaxial connector.

9. The coaxial connector of claim 1 wherein said connector comprises an RF cable micro-connector.

10. The coaxial connector of claim 2 including having a contact tongue arranged and formed on the first conductor part such that when there is not a complementary coaxial connector inserted in the coaxial connector, the contact tongue makes electrical contact with the second conductor part of the switching mechanism and, when there is a complementary coaxial connector inserted in the coaxial connector, the electrical contact between the first and second conductor parts is broken due to the radial expansion or compression of the first conductor part by the complementary coaxial connector

11. The coaxial connector of claim 2 wherein the first conductor part comprises a sheet of resilient material formed into a roll.

12. The coaxial connector of claim 3 wherein the first conductor part comprises a sheet of resilient material formed into a roll.

13. The coaxial connector of claim 4 wherein the coaxial connector is formed to hold the first conductor part in a rolled state in opposition to an elastic resilient force, thus causing the contact tongue of the first conductor part to make contact with the contact area of the second conductor part when there is not a complementary coaxial connector inserted in the coaxial connector.

14. The coaxial connector of claim 2 having the first conductor part including a funnel shaped form.

15. The coaxial connector of claim 3 having the first conductor part including a funnel shaped form.

16. The coaxial connector of claim 2 wherein the first conductor part includes a slit in the axial direction.

17. The coaxial connector of claim 3 wherein the first conductor part includes a slit in the axial direction.

18. The coaxial connector of claim 2 wherein the first conductor part comprises a center-conductor part of the coaxial connector.

19. The coaxial connector of claim 3 wherein the first conductor part comprises a center-conductor part of the coaxial connector.

20. A coaxial connector for the insertion of a complementary coaxial connector comprising:
a switching mechanism having an electrical contact, arranged and formed in the coaxial connector such that the electrical contact is closed when there is not a complementary coaxial connector inserted in the coaxial connector, and the electrical contact is open when there is a complementary coaxial connector inserted in the coaxial connector, wherein the switching mechanism includes:
a cylindrical first conductor part radially expandable or compressible with elastic resilience and which makes electrical contact with a second conductor part of the switching mechanism, the first conductor part arranged and formed such that the complementary coaxial connector which is inserted in the coaxial connector expands the first conductor part radially or compresses the first conductor part radially to break electrical contact between the first conductor part and the second conductor part; and
the contact tongue making electrical contact with the second conductor part of the switching mechanism such that when there is a complementary coaxial connector inserted in the coaxial connector, the electrical contact between the first and second conductor parts is broken due to the radial expansion or compression of the first conductor part by the complementary coaxial connector;
the first conductor part arranged coaxially in the coaxial connector, comprising a sheet of resilient material formed into a roll, and including a funnel shaped form; and
the coaxial connector formed to hold the first conductor part in a rolled state in opposition to an elastic resilient force, thus causing the contact tongue of the first conductor part to make contact with the contact area of the second conductor part when there is not a complementary coaxial connector inserted in the coaxial connector.
